(19) United States
(12) Patent Application Publication
(10) Pub. No.: US 2016/0252237 A1
(43) Pub. Date: Sep. 1, 2016

(54) DEVICES AND METHODS FOR GENERATING SPINNING LASER BEAM SPECIAL EFFECTS

(71) Applicant: RUBICON GROUP HOLDING LIMITED, Tortola (VG)

(72) Inventors: Emery Alan BROWN, Tujunga, CA (US); Adrian MONGELI, West Hills, CA (US)

(73) Assignee: Rubicon Group Holding Limited, Tortola (VG)

(21) Appl. No.: 15/028,896

(22) PCT Filed: Oct. 14, 2014
(86) PCT No.: PCT/US14/60383

§ 371 Date: Apr. 12, 2016

Related U.S. Application Data
(60) Provisional application No. 61/890,933, filed on Oct. 15, 2013.

(51) Int. Cl. F21V 14/04; F21V 7/00

(52) U.S. Cl. CPC F21V 14/04; F21V 7/0008; F21W 2131/40

(57) ABSTRACT

Devices and methods that generate spinning laser beam effects include various elements configured to create a circular light shaft effect, which appears to maintain a constant diameter (i.e. a zero-degree beam spread) throughout the length of the laser beam. The devices disclosed herein include, among other elements, a glass plate and directional mirror assembly, an axial mirror spinner assembly, a frame assembly, a laser source device, and a motor.

### CROSS-REFERENCE TO RELATED APPLICATIONS

This application is a United States national stage application (under 35 USC §371) of PCT/US2014/060383, filed Oct. 14, 2014, which claims benefit of U.S. Application No. 61/890,933, filed Oct. 15, 2013, the entirety of each of which is incorporated herein by reference.

### BACKGROUND OF THE INVENTION

The field of the present invention relates to devices and methods that generate spinning laser beam special effects, and particularly devices and methods that can create a circular light shaft effect, which appears to maintain a constant diameter (i.e. a zero-degree beam spread) throughout the length of the beam.

The themed entertainment industry is always being challenged to create new, exciting, fun, and seemingly magical special effects. Generating beams of lights which appear to be laser beams is one type of special effect, which is often incorporated in themed entertainment attractions. Unfortunately, current devices that generate laser beam special effects have limited capabilities.

To date, a special effects device has not been developed or marketed, which can spin a laser beam at a specific diameter to simulate a shaft of light, while also using a small form-factor package design. Many devices are capable of generating large spot-lights. But, these devices are unable to reach a zero-degree beam spread. During their use, a beam of light will become wider as the beam travels. Other known devices, which are used to generate laser beams, are able to spin light from a single-point output source. But, these devices are unable to spin light at a point of origin to generate beams of light having larger circular diameters. Although these types of devices are likely useful for their intended purpose, each type clearly has limited capabilities

Considering the continuing need for new and unique special effects in the themed entertainment industry as well as the limited capabilities of some laser beam special effects devices, there is a need for improved devices and methods for generating spinning laser beam special effects. The present invention fulfills these needs and provides further related advantages, as described herein.

### BRIEF SUMMARY OF THE INVENTION

Disclosed herein are devices and methods that generate spinning laser beam effects. Such devices and methods include various elements configured to create a circular light shaft effect, which appears to maintain a constant diameter throughout the length of the laser beam. The devices disclosed herein include, among other elements, a glass plate and directional mirror assembly, an axial mirror spinner assembly, a frame assembly, a laser source device, and a motor. Methods of using the devices are also disclosed herein.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1A shows a side view of one configuration of a device that generates a spinning laser beam special effect and a laser beam, with a zero-degree beam spread, generated by the device;

FIG. 1B schematically shows a device that generates a spinning laser beam special effect and a laser beam, with a zero-degree beam spread, generated by the device;

FIGS. 2A and 2B show perspective views of the device shown in FIG. 1;

FIG. 3 shows an exploded view of a device that generates a spinning laser beam special effect;

FIG. 4A shows a top view of a glass plate and directional mirror assembly;

FIG. 4B shows a side perspective view of a glass plate and directional mirror assembly shown in FIG. 4A;

FIGS. 5A and 5B show top perspective views of an axial mirror spinner assembly for use in a device that generates a spinning laser beam special effect;

FIG. 5C shows a bottom view of an axial mirror spinner assembly;

FIG. 6 schematically shows a perspective view of a partially-assembled device that generates a spinning laser beam special effect;

FIG. 7 schematically shows a side view of a device that generates a spinning laser beam special effect and a beam angular range ₂for the device;

FIGS. 8A-8G show examples laser beam special effects and axial spinner mirror assembly configurations;

FIGS. 9A-9G show examples of laser beams, which are created using a device that generates a spinning laser beam special effect;

FIG. 10A shows a perspective view of a device that generates a spinning laser beam special effect, which includes a crystal formation positioned on the device, and a laser beam special effect generated by the device;

FIG. 10B shows a side view of the device shown in FIG. 10A and a laser beam special effect generated by the device;

FIG. 10C shows a side perspective view of the device shown in FIG. 10A and laser beam special effects generated by the device;

FIG. 11 shows a front view of a device that generates a spinning laser beam special effect and a laser beam special effect generated by the device;

FIG. 12 schematically shows a side view of second configuration of a device that generates a spinning laser beam special effect; and

FIG. 13 schematically shows a side view of third configuration of a device that generates a spinning laser beam special effect.

### DETAILED DESCRIPTION OF THE INVENTION

Disclosed herein are devices and methods that generate spinning laser beam special effects, and particularly devices and methods including various elements that create a circular light shaft effect, which appears to maintain a constant diameter (i.e. a zero-degree beam spread) throughout the length of the beam. Use of laser beam special effects generated by these devices and methods may be used in any trade or industry that includes interactives, tangible and virtual UIs, show action, visual illusions, lighting effects, simulations, stage/movie props, fountain/water lighting, response feedback devices, and atmospheric effects. This listing, however, is not exhaustive. The devices and methods disclosed herein may be used in any trade or industry that would benefit from increased entertainment value by using laser beam special effects.

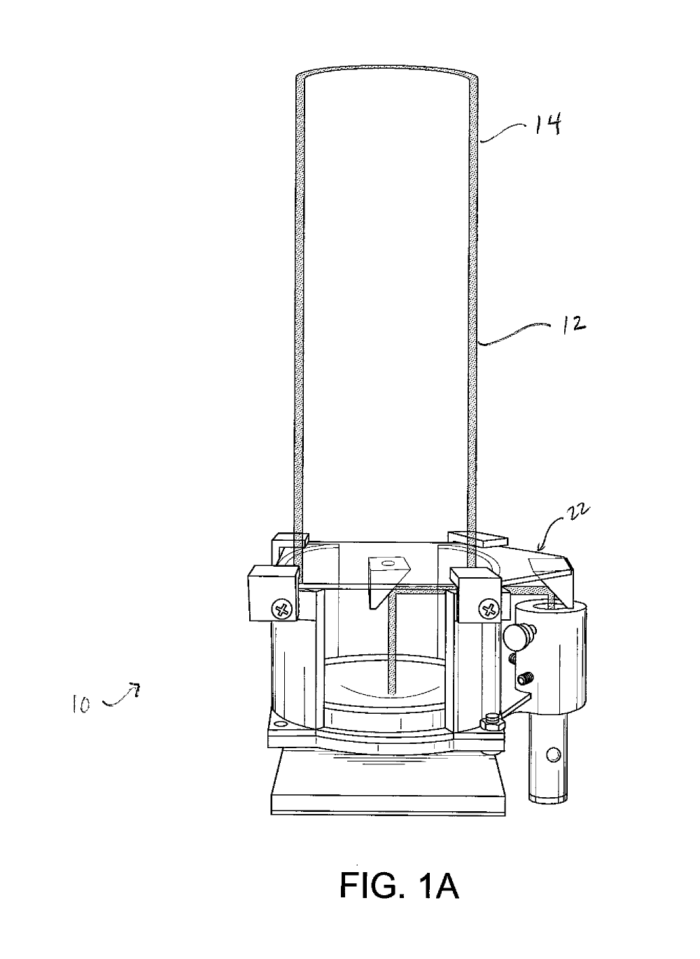

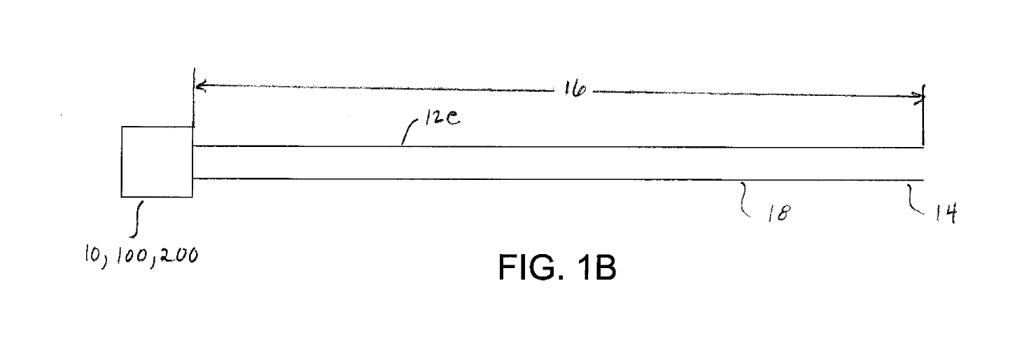

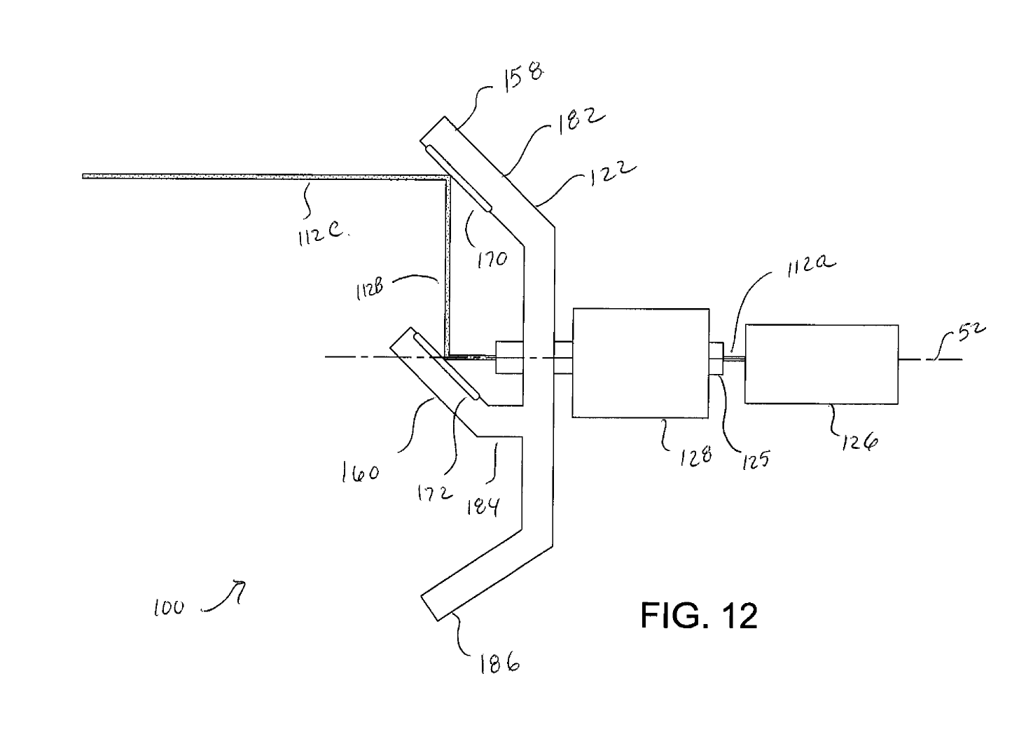

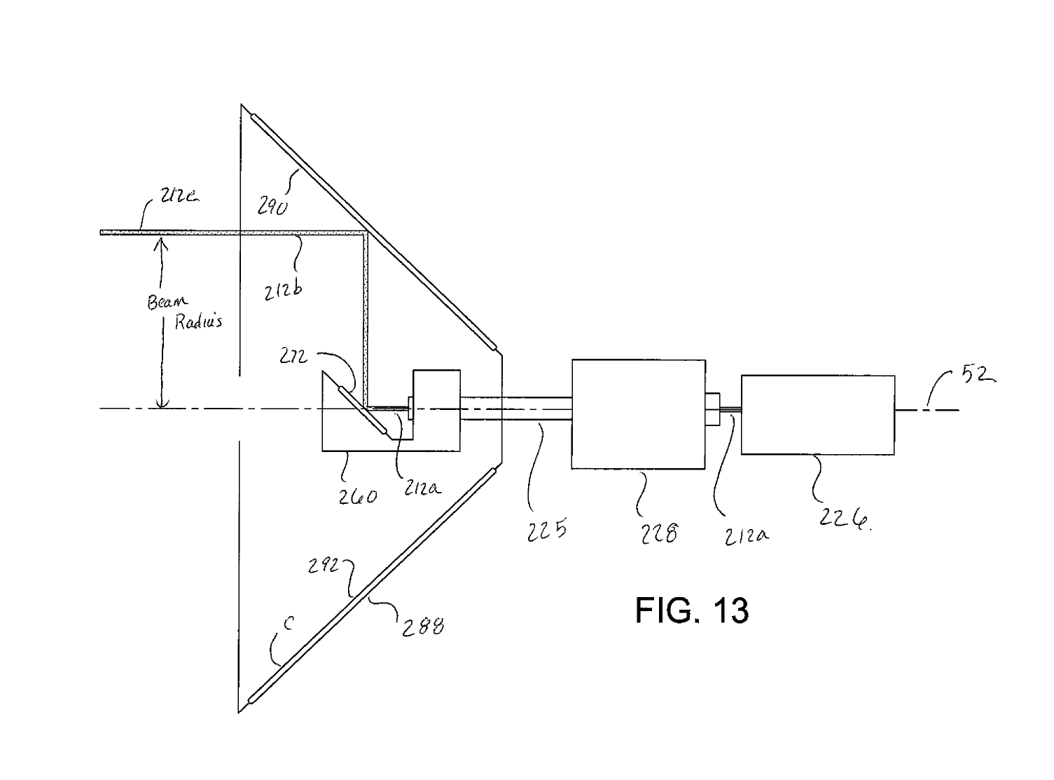

FIG. 1A shows a first configuration of a device 10 that generates a laser beam special effect 12 with a zero-degree beam spread 14. Other device configurations 100, 200 are shown in FIGS. 12 and 13. FIG. 1B schematically and generically shows a device 10, 100, 200 and an outgoing laser beam 12e with a zero-degree beam spread 14 generated by the device, which extends the full length L of the outgoing laser beam 12e. The term “zero-degree beam spread” as used herein refers to the substantially parallel outer beam boundary lines 16, 18 generated by the device 10. To date, no known special effects device can produce a laser beam special effect with a zero-degree beam spread.

The zero-degree beam spread special effect and other special effects created by the devices disclosed herein can be used for laser beam simulations, illusions, and other unique show-action designs. Special effects generated by these devices may also be used as tangible user-interfaces. For example, guests of a game or attraction may pass their hands through a laser beam special effect generated by the device(s) to trigger events during gameplay or while they are participating in attraction events.

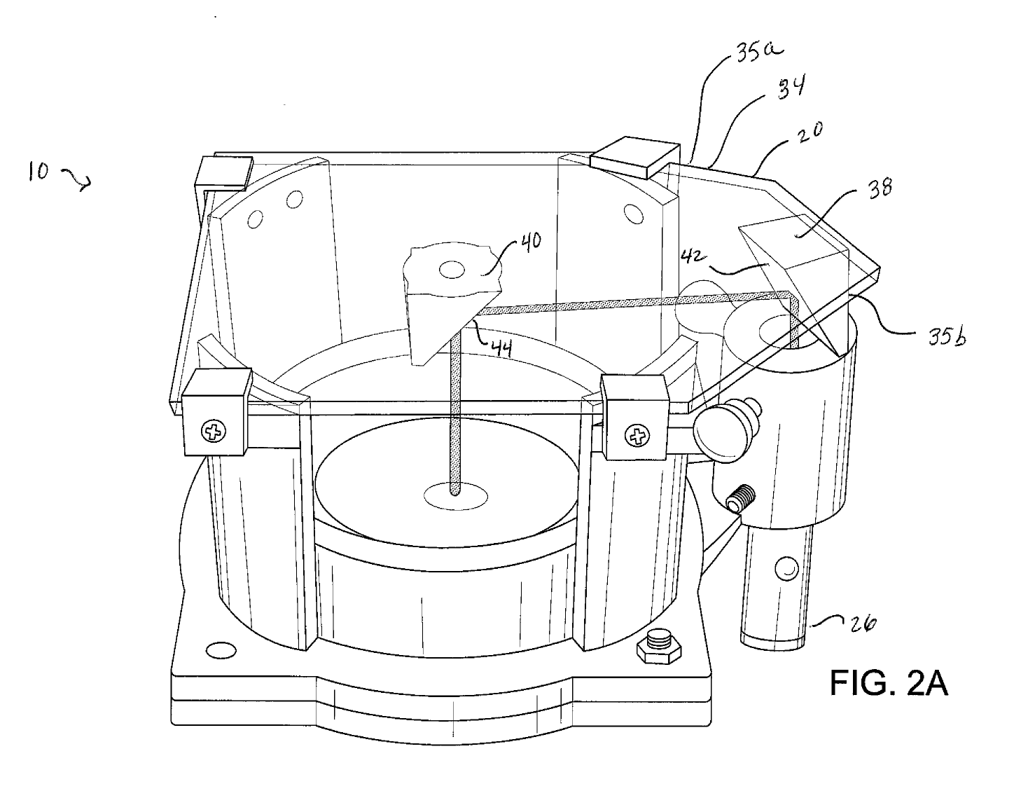

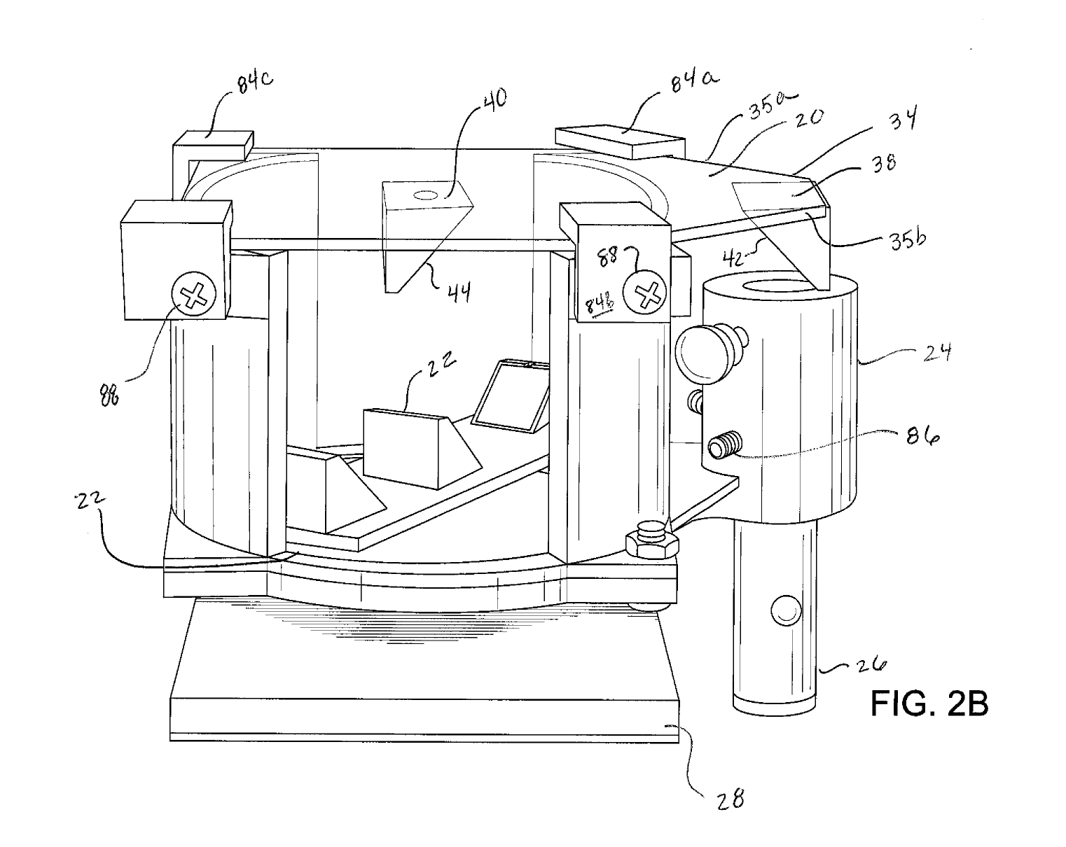

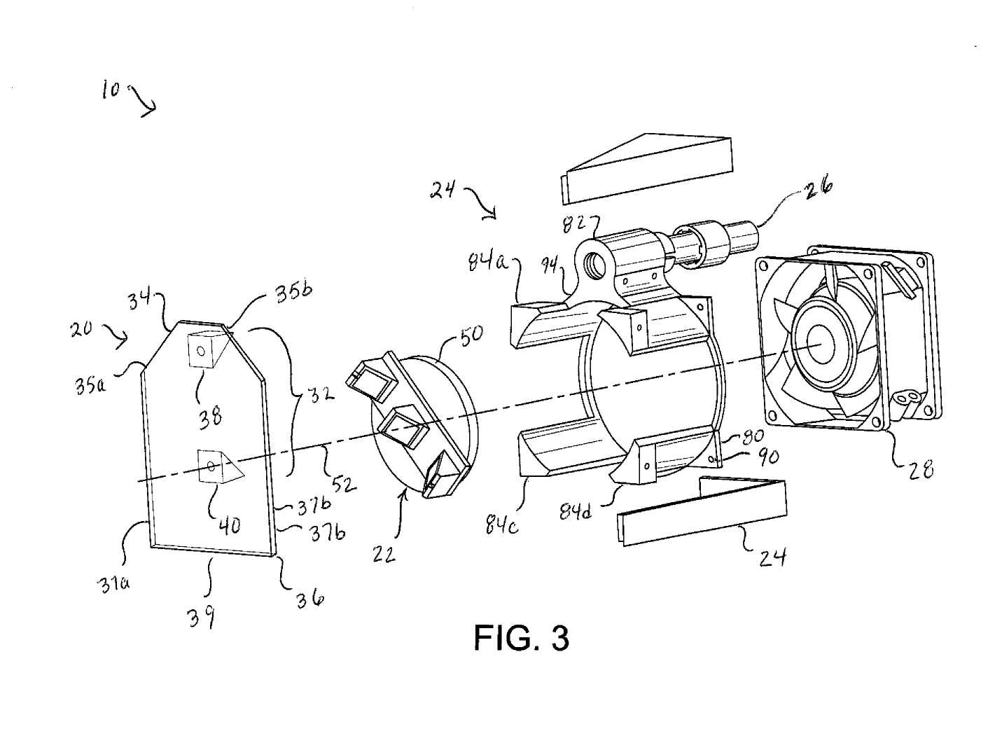

FIGS. 1A, 2A, and 2B show various perspective view of the device 10, while FIG. 3 shows an exploded view of the device 10. Referring particularly to FIG. 3, this configuration of the device 10 includes a glass plate and directional mirror assembly 20, an axial mirror spinner assembly 22, a frame assembly 24, a laser source device 26, and a motor 28. Upon assembly of these elements, the device 10 is able to generate laser beam special effects and particularly a laser beam effect with a zero-degree beam spread, as shown particularly in FIG. 1A.

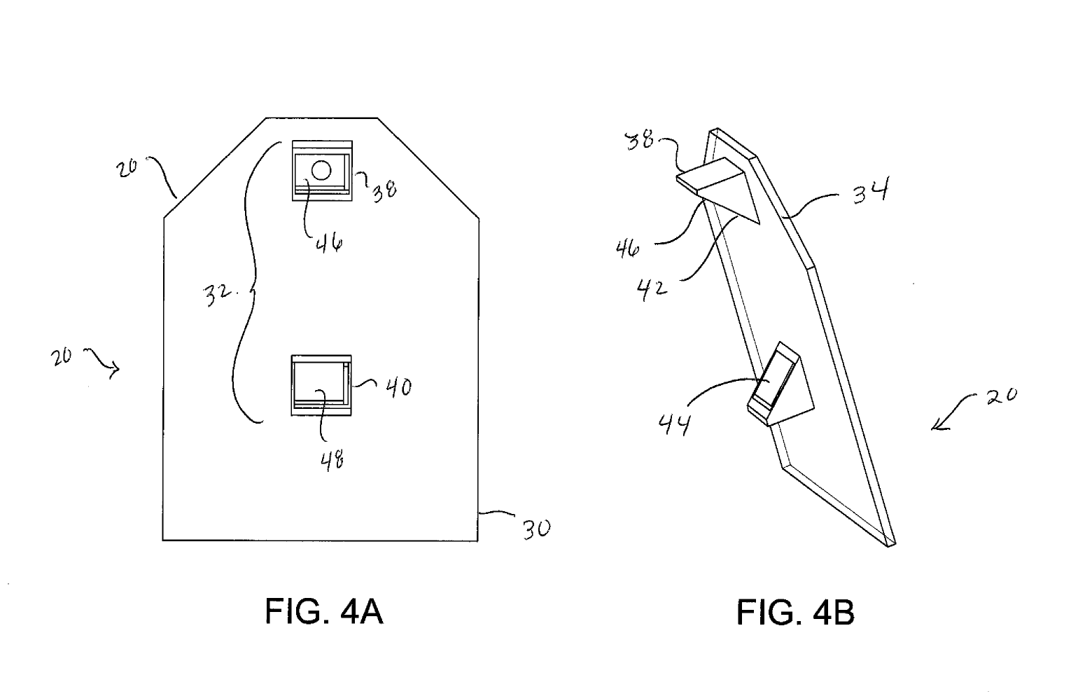

The glass plate and directional mirror assembly 20 includes a glass plate 30 and a plurality of mirror mounts 32. The glass plate 30 preferably has an elongated pentagon shape, with an upper section 34, having angled sides 35a, 35b and a lower section 36 having sides 37a, 37b that are substantially parallel and a bottom 39. The plurality of mirror mounts 32 includes an upper glass mirror mount 38 positioned on the upper section 34 of the glass plate and a lower glass mirror mount 40 positioned on the lower section 36 of the glass plate. Each mirror mount 38, 40 includes an angled surface 42, 44 upon which upper and lower directional mirrors 46, 48 are attached. One configuration of a glass plate and directional mirror assembly 20 is particularly shown in FIGS. 4A and 4B.

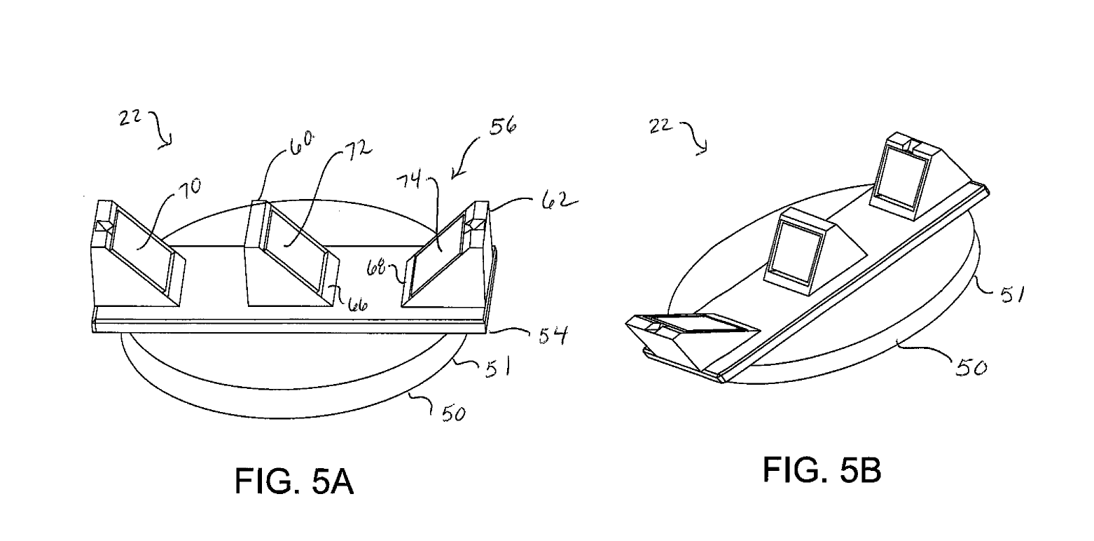

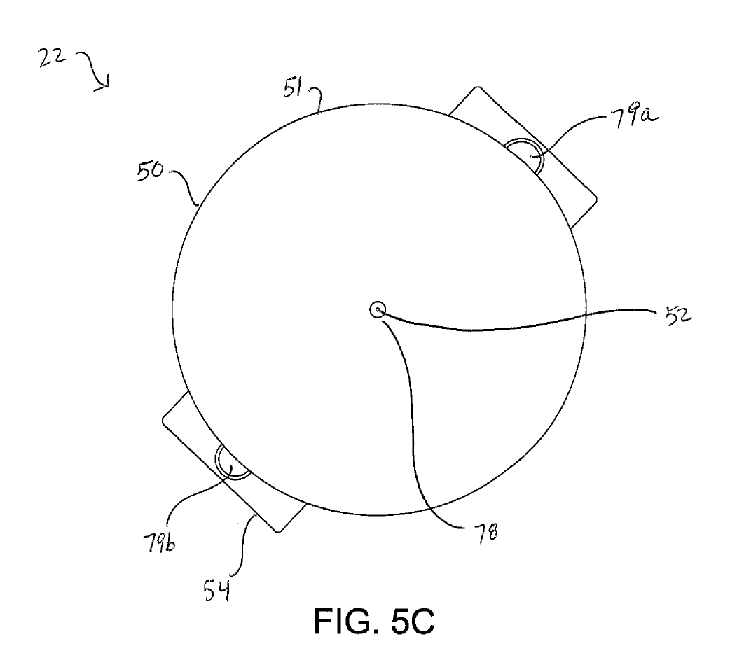

FIGS. 5A and 5B show top perspective views of the axial mirror spinner assembly 22 shown in FIG. 3. The assembly 22 includes a disc-like base 50, having a circular outer periphery 51. The base 50 is configured to spin about a central axis 52 (FIG. 5B). Mounted onto the base 50 is a support element 54 that extends slightly beyond the outer diameter of the base, upon which a plurality of mirror mounts 56 are attached. This configuration includes an upper mirror mount 58, a central mirror mount 60, and a lower mirror mount 62. Attached or mounted onto an angled surface 64, 66, 68 of each respective mirror mount are an upper mirror 70, a central mirror 72, and a lower mirror 74. The upper mirror mount 58 and its mirror 70 and the central mirror mount 60 and its mirror 72 are oriented toward the lower mirror mount 62 and its mirror 74. FIG. 5C show the bottom surface 76 of the axial mirror spinner assembly 22 shown in FIGS. 5A and 5B. This view shows an aperture 78, which serves as a point of rotation corresponding to central axis 52, and fastening elements 79a, 79b that connect the support element 54 to the base 50.

During operation of the device 10, the diameter of the base 50 determines the generated diameter of the laser beam. For example, a larger base diameter would create a larger beam shaft diameter and a smaller base diameter would create a smaller laser beam shaft diameter. As such, the device 10 can be designed to produce an outgoing laser beam 12e, having a shaft of any specified diameter.

Referring particularly to FIGS. 2B and 3, one configuration of a frame assembly 24 includes a base stabilization support 80, a laser source support 82, and glass plate stabilization elements 84a, 84b, 84c, 84d. Together, these elements of the frame assembly substantially align the laser source device, the motor, and the axial mirror spinner assembly. Upon complete assembly, the device is preferably centrally aligned with respect to central axis 52 (FIG. 3). The frame assembly 24 may be assembled using fastening elements 86, such as screws 88 and nut and bolt assemblies 89 (FIG. 2B), for example. To accommodate the fastening elements 86, the frame assembly also includes apertures 90, as shown in FIG. 3. The laser source support configuration shown includes a tubular housing 92, having an internal surface configured to receive the laser source device 26 and laser source support legs 94 which mount onto the base stabilization support 80.

The frame assembly may include one or more elements manufactured from plastic and/or metallic materials, as shown in FIG. 2B. Where metal is a material of choice, one more adjustable interfaces may be provided, which allow for the adjustment of one or more fastening elements, one or more directional mirrors, and the motor. These adjustable interfaces allow for adjustment of pitch and yaw of the motor and the axial mirror spinner assembly. The frame assembly may also be used for mounting the assembled device to other products such as external enclosures, lighting trusses, equipment stands, rigging equipment, etc.

The laser source devices 26, 126, 226 (See FIGS. 3, 12, and 13) for each device configuration is used to create an initial and preferably steady laser beam. The laser source device can be any type of laser, laser module or laser assembly. In preferred configuration, the laser source device creates an initial laser beam 12, having a diameter ranging from about 0.5 mm to about 5 mm maximum. The laser source device is also preferably has a power rating that ranges from about 5 mW to about 2000 mW. The laser beam, which is generated from or created by the laser source device, can be any color or combination of colors, including, but not limited to RGB (Red, Green, Blue) laser modules that would give a full spectrum of color. The power rating, beam diameter, and/or color, may impact the overall length and brightness of the outgoing laser beam created by the devices disclosed herein.

The motor 28 transmits energy to the axial mirror spinner assembly 22 such that the assembly 22 can spin about the central axis 52. The motor may be configured to run runs at whatever speed creates the desired laser beam effect. Such speeds can range, for example, from about 1 RPM to about 5,000 RPM, depending on laser beam diameter and the desired special effect (color changing, solidness of beam, etc.). For the device configuration shown in FIGS. 1A, 2A, and 2B, a standard off-the-shelf brushless DC computer fan motor was used achieve the desired functionality. Other types of motors, however, may be utilized in the devices described here. For example, any type of brushless or stepper adjustable-speed motor configured to run on DC power between 12V and 24V, or AC power between 100V and 250V may be specified.

Such motors would support rotations-per-minute between about 1 RPM and 5,000 RPM to achieve different speeds—where slower speeds create a flickering effect, and faster speeds create an effect that appears as a smooth shaft of light. The motor (depending on design direction) can also be provided with a solid shaft or a hollow-shaft, as shown in FIGS. 12 and 13.

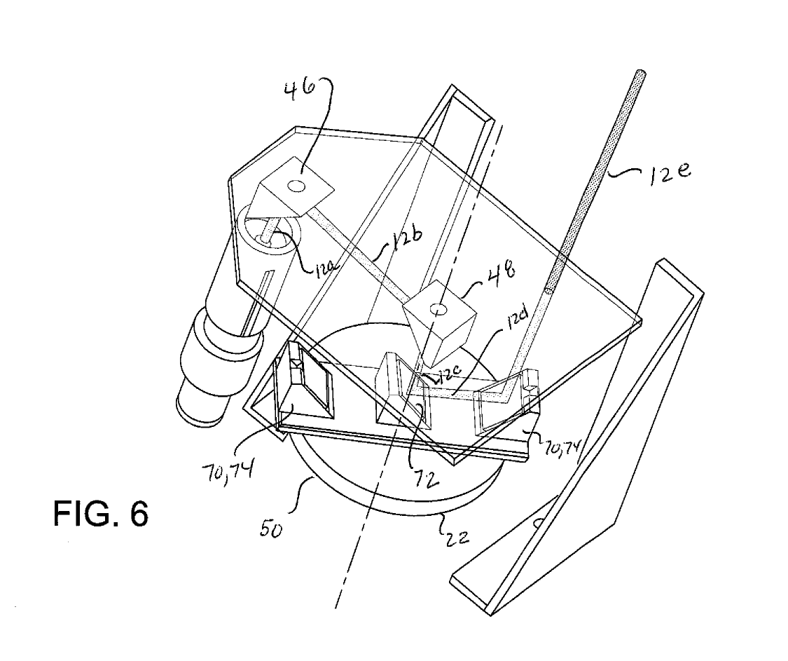

FIG. 6 shows a partially assembled perspective view of device elements. During use of the device 10, the laser beam 12a is generated by the laser source device 26 and directed to the center of the upper directional mirror 46. The laser beam 12b is then inwardly directed or bounced about 90-degrees to the center of the lower directional mirror 48. The laser beam 12c is then directed or bounced about 90-degrees to the central mirror 72 of the axial mirror spinner assembly 22. The laser beam 12d is then bounced out to mirror 70 or 74 of the axial mirror spinner assembly with the other unused mirror of the spinner assembly acting as a counterweight. Thereafter, the outgoing laser beam 12e is directed to exit the device and travel along a length of a projected path (i.e. a laser beam shaft).

For effective operation, the laser beam 12 should hit a center area of each mirror, otherwise the resulting beam shape will be affected. Preferred configurations also include mirror/beam alignment features.

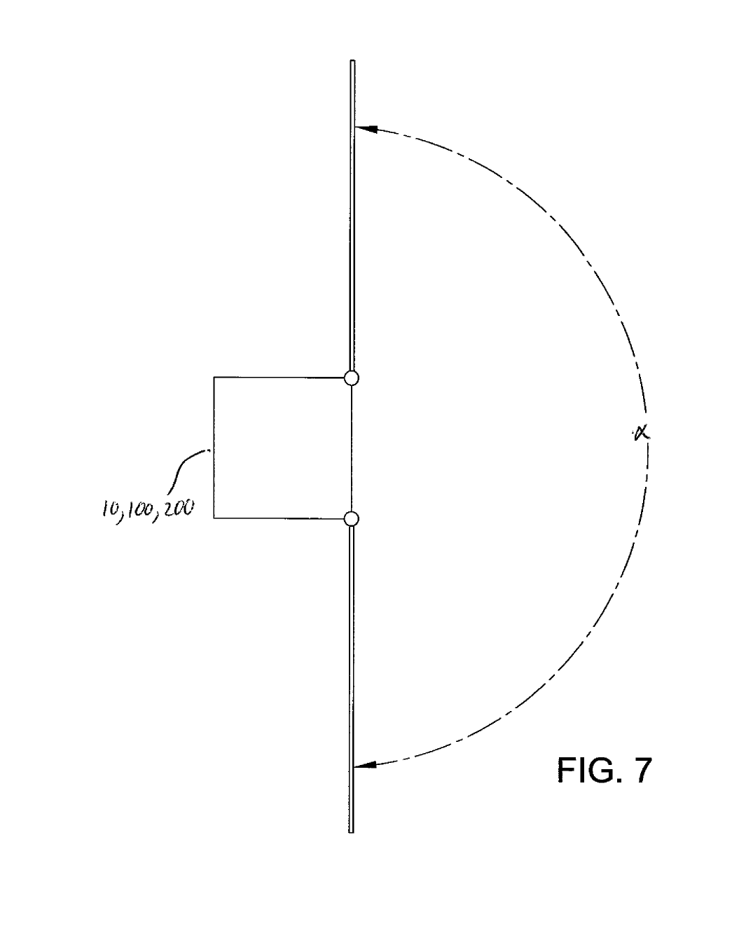

FIG. 7 shows an expected travel path for generated laser beams, being defined by an angle a. In these device configurations, laser beams may travel a maximum of 90 degrees, a minimum of −90 degrees, with a total travel of 180-degrees. By adjusting the diameter and angle of an outgoing laser beam, a variety of special effects can be generated.

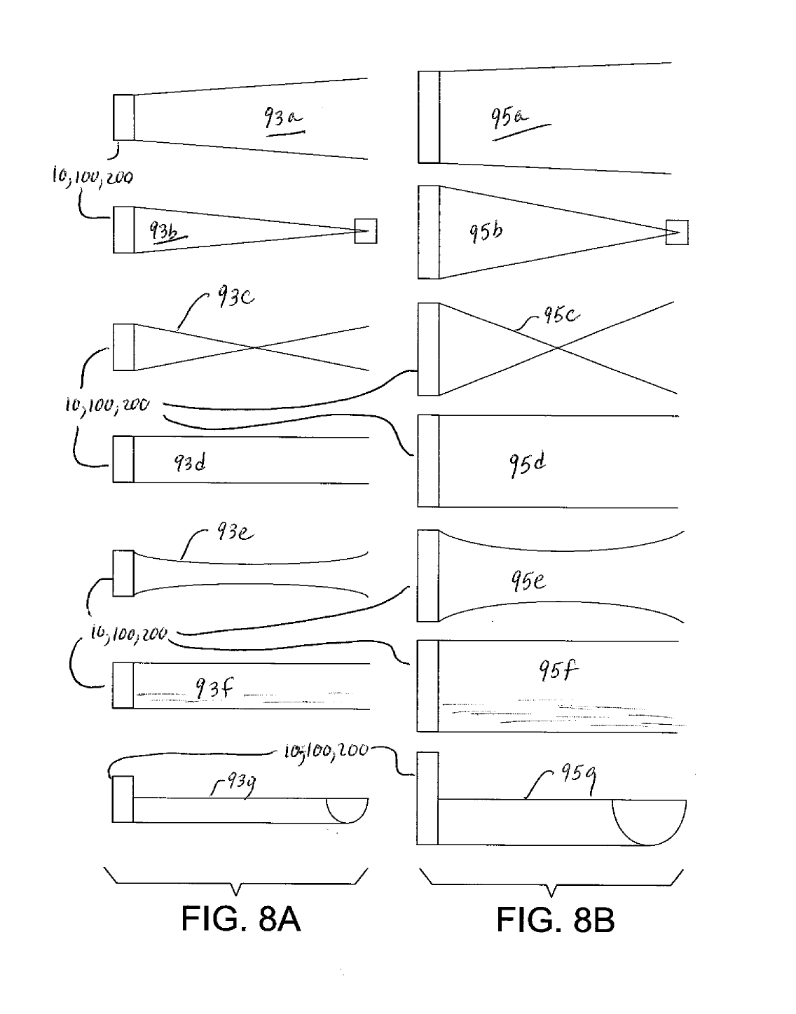

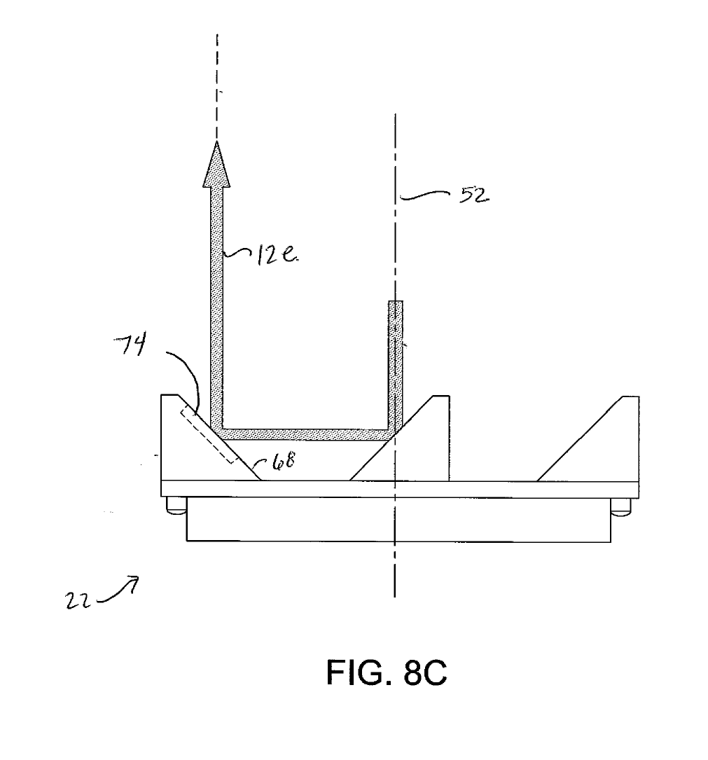

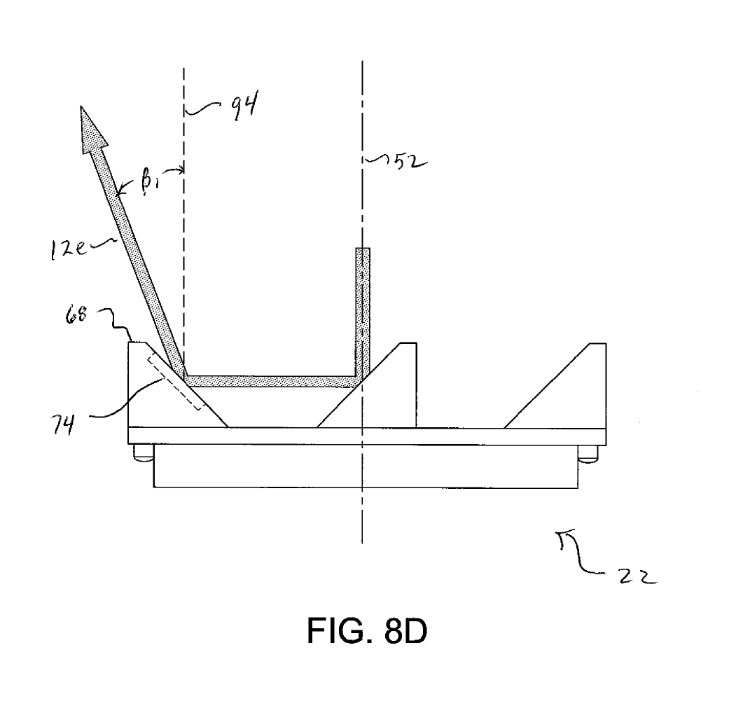

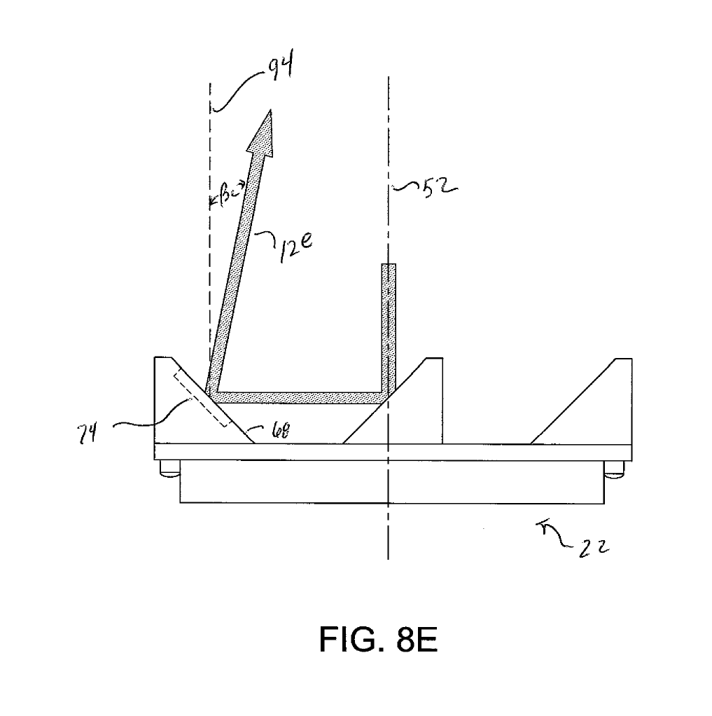

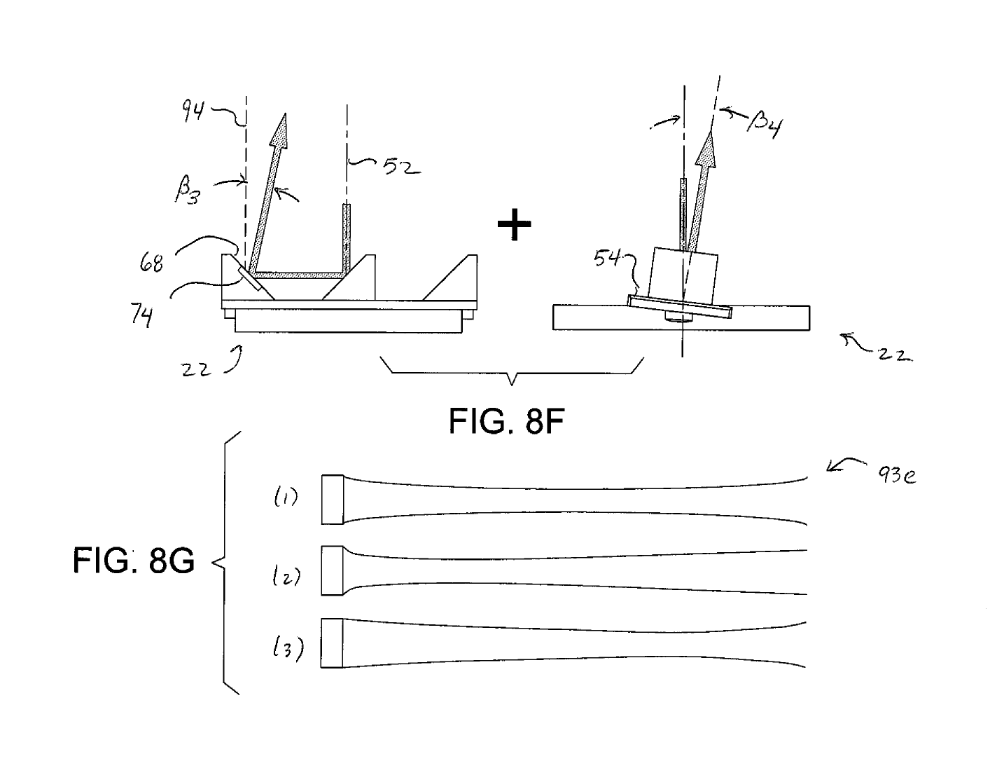

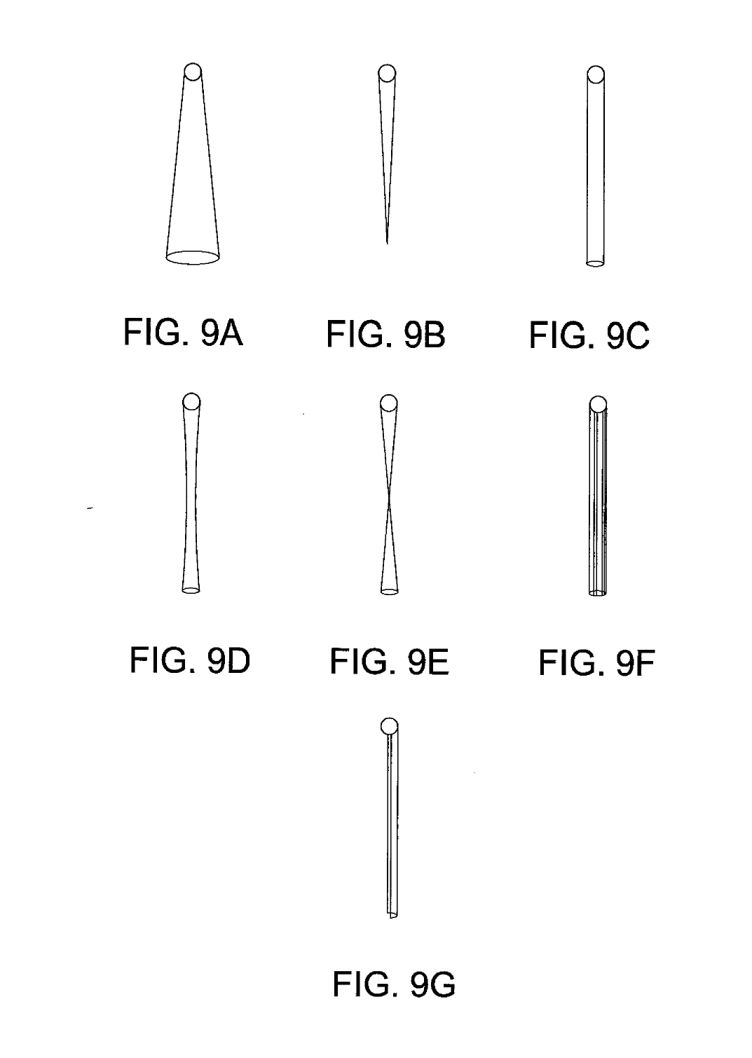

FIGS. 8A-9G show various types of beam effects that may be created using device configurations 10, 100, 200 disclosed herein. FIG. 8A shows various laser beam effects that may be created with a device, having a smaller base diameter and FIG. 8B shows various laser beam effects that may be created with a device, having a larger base diameter. The enlarging beam effects 93a, 95a, the target beam effects 93b, 95b, the crossing beam effects 93c, 95c, and 0-degree spread beam effects 93d, 95d may be created during operation of a device 10, 100, 200 while the mirror angle with respect to a central axis 52 is adjusted.

FIG. 8C shows the direction of an outgoing laser beam 12e used to create a 0-degree spread effects 93d, 95d. For the 0-degree spread effect, the outgoing laser beam 12e is substantially parallel with the central axis 52 and collinear with mirror axis 94, while the mirror axis 94 and the central axis 52 are substantially parallel. FIG. 8D shows the direction of an outgoing laser beam 12e used to create an enlarging beam effect 93a, 95a. For the enlarging beam effect, the mirror 74 and/or the angled surface 68 is adjusted to create an outwardly projecting (i.e. away from the central axis 52) outgoing laser beam 12e, resulting in an angle β1. FIG. 8E shows the direction of an outgoing laser beam 12 used to create either target beam effects 93b, 95b or crossing beam effects 93c, 95c. For these types of effects, the mirror 74 and/or the angled surface 68 is adjusted to create an inwardly projecting (i.e. toward the central axis 52) outgoing laser beam 12e, resulting in an angle β2.

FIG. 8F shows the adjustments of the spinner assembly 22 used to create warped beam effects 93e, 95e. These effects are created by) adjusting (1) the mirror 74 and/or the angled surface 68 inwardly (i.e. toward the central axis 52), resulting in an angle β and (2) the support element 54 toward the right or left (i.e. leaning into or away from the rotation), resulting in an angle while rotating the spinner. Depending on the amount of adjustment, warp beam effects 93e can vary along their length, as shown in FIG. 8G, for a small diameter laser beam.

Referring back to FIGS. 8A and 8B, a color effect beam is created by controlling when the laser source ROB color is turned on and off during one spin cycle. Different on/off durations for desired colors can create different color effects. This type of control would be handled by adding circuitry to the device to control the on/off timing of colors. The color effect beam can also be combined with other special effects, as desired. An arc beam effect is created by controlling when the laser is turned on and off during one spin cycle. Different on/off durations create different arc angles. This type control would also be handled by adding circuitry to the device to control on/off timing of the laser beam. Like the color effect, the arc effect can also be combined other special laser beam effects.

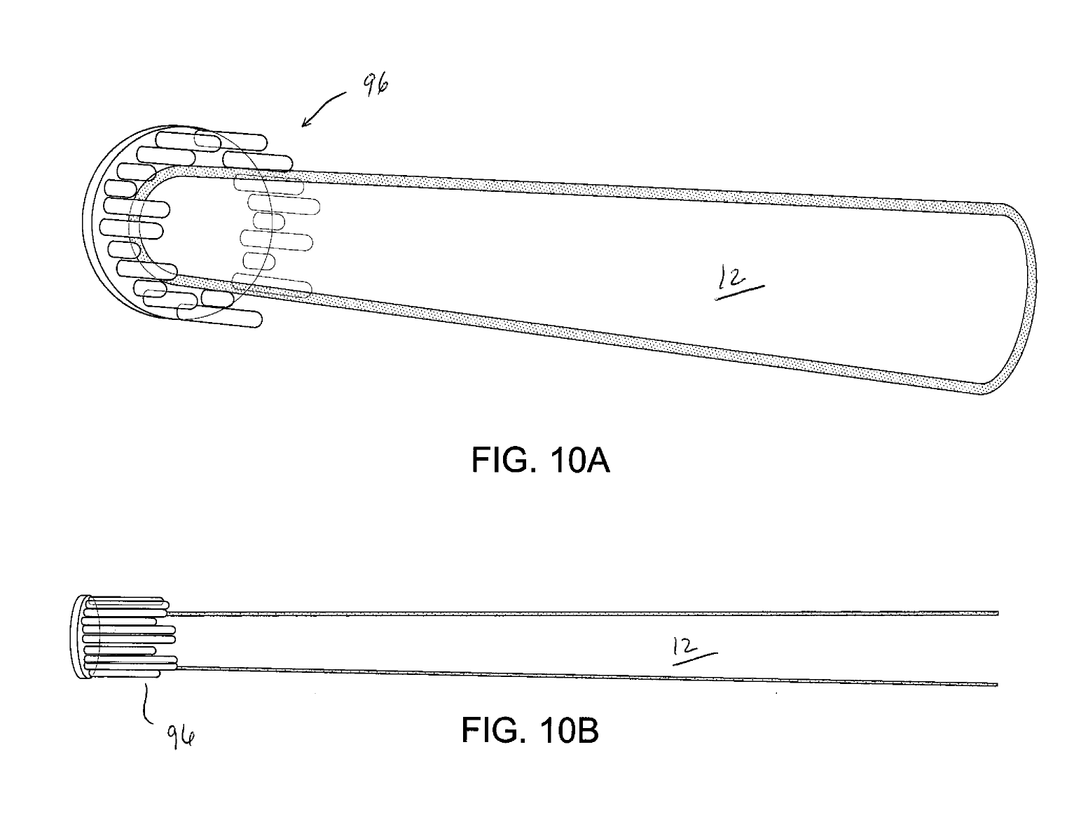

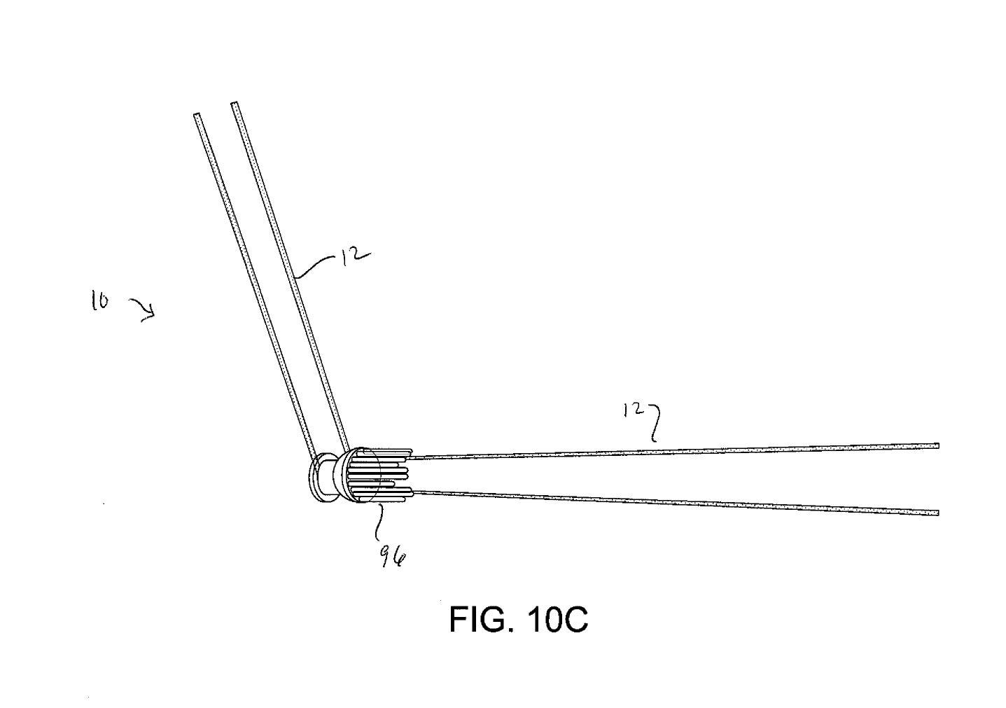

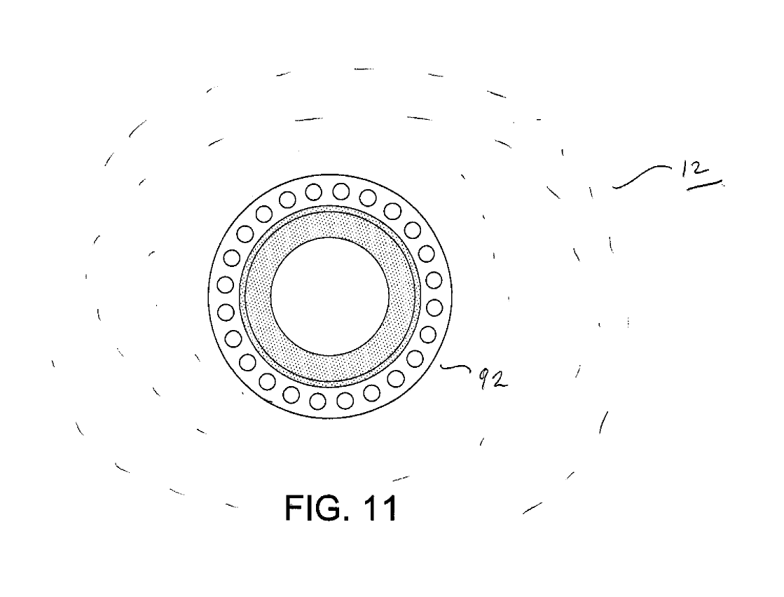

FIGS. 10A-11 show the device 10 in use while a crystal-like formation 96 is mounted to the device.

FIGS. 12 and 13 show other device configurations 100, 200. The device 100 shown in FIG. 12 includes an axial mirror spinner assembly 122, including an upper mirror mount 158 with an upper mirror 170 and a central mirror mount 160 with a central mirror 172. In this configuration, a disc-like base 150 is integrally formed with the mirror mounts to include arms 182, 184 and a counterweight 186. The device also includes a frame assembly 124 (not shown), a shaft 125, a laser source device 126, and a motor 128.

During operation of the device 100, the laser beam 112a is generated by the laser source device 126 and directed to the center of the central mirror 172. The laser beam 112b is then directed or bounced about 90-degrees to the center of the upper mirror 170. Thereafter, the outgoing laser beam 112c is directed to exit the device and travel along a length of a projected path (i.e., laser beam shaft).

The device configuration shown in FIG. 13 allows the beam shaft diameter to automatically be adjusted by moving the axial mirror spinner assembly 222 forwards or backwards while it is positioned inside a mirrored cone-shaped element 288. A mirror coating 290 is included on an interior surface 292 of the cone-shaped element. The axial mirror spinner assembly 222 includes a central mirror 272 mounted onto a central mirror mount 260. The device also includes a frame assembly 224 (not shown), a shaft 225 a laser source device 226, and a motor 228.

During operation of this device 200, the laser beam 212a is generated by the laser source device 226 and directed to the center of the central mirror 272. The laser beam 212b is then directed or bounced about 90-degrees onto the mirrored cone-shaped element 288. Thereafter, the outgoing laser beam 112c is directed to exit the device and travel along a length of a projected path (i.e., laser beam shaft).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A device for generating a spinning laser beam special effect, comprising:
a laser source device that generates a laser beam having a zero-degree beam spread;
a motor; and
an axial mirror spinner assembly, coupled to the motor and the laser source device, comprising a plurality of mirrors configured to direct the laser beam generated by the laser source device and create the spinning laser beam special effect.

2. The device of claim 1, further comprising a frame assembly coupled to the axial mirror spinner assembly.

3. The device of claim 1, further comprising a glass plate and directional mirror assembly coupled to the axial mirror spinner assembly.

4. The device of claim 2, wherein the glass plate and directional mirror assembly comprise a separate plurality of mirror mounts.

5. The device of claim 1, wherein the axial mirror spinner assembly comprises an upper mirror mount, a central mirror mount and a lower mirror mount.

6. The device of claim 1, wherein at least one of the plurality of mirrors are mounted on an angled surface.

7. A method for generating a spinning laser beam special effect, using the device claimed in claim 1, the method comprising:
generating a laser beam from a laser source device;
directing the laser beam generated by the laser source device to a plurality of mirrors configured positioned on an axial mirror spinner assembly to direct the laser beam; and
spinning the axial mirror spinner assembly to create the spinning laser beam special effect.
